(19) United States
(12) Patent Application Publication
(10) Pub. No.: US 2005/0073146 A1
(43) Pub. Date: Apr. 7, 2005

(54) Tube section piece

(76) Inventor: Philipp Daehne, Brumby (DE)

Correspondence Address: SHLESINGER, ARKWRIGHT & GARVEY LLP, 1420 KING STREET, SUITE 600, ALEXANDRIA, VA, 22314, US

(21) Appl. No.: 10/819,355

(22) Filed: Apr. 7, 2004

(30) Foreign Application Priority Data
Apr. 7, 2003 (DE) 103 16 014.0

(51) Int. Cl. F16L 27/00

(52) U.S. Cl. 285/272

(57) ABSTRACT

Tubular section piece for providing and influencing a fluid (80, 81) for a container (100) for water organisms (120), comprising a fixed tubular element (10, 11, 12) and a moveably supported tubular element (20, 21), wherein the two tubular elements (10, 11, 12, 20, 21) are rotatable with respect to one another by means of a driving element (30), and a device for distributing fluid, comprising a tube section piece (1) according to the invention.

### FIELD OF THE INVENTION

The invention concernes a tube section for providing and influencing a fluid in a container for living water animals and other water organisms, as well as a device for distributing the flow in a tube section piece.

### DESCRIPTION OF THE PRIOR ART

So called biological fluids, in the present case water, in which organisms and nutrients, as for example oxygen are contained, are for example present in aquaria or artificial ponds. Within such aquaria or ponds, there is a need for a water movement or flow, so that the microfauna or the macrofauna contained therein does not die as a result of an unbalanced transport of nutrients, which is among other things considered to be the reason for a biological collapse of such artificially prepared habitats.

It is known that for example in the context of garden ponds and aquaria a flushing or a water circulation which is necessary in this respect, is created by uniform or repeated movements. However, the inlet or supply tubes which to a large extent are rigid and immoveable, are more likely to create monotonous circular flows that only partly allow for a satisfactory distribution of nutrients.

Devices, which are currently available on the market, typically consist of a unit, which is a combination of a circulation-pump with a moveable nozzle and optionally a filter unit, wherein, however, due to the size, the optical positioning and possibly occuring maintainance work, limitations usually arise in the use of, for example, aquaria.

In addition, a rotational hinge is known which, however, as shown in DE 101 35 533 A1, is used in high pressure devices, and therefore is not suitable for aquaria and the like. Further, devices like a rotatable insert for commercially available hose nipples for reversing a flow (DE 199 51 162 A1), a hose connection for a household-security-hose (DE 100 46 922 A1) or tube connecting systems having a tube coding (DE 101 16 566 A1) are used especially in an household environment.

In the document DE 202 07 127 U1 a flow distributor for half-sided immersion into aquaria is shown. Therein, an actuation of a water outlet opening is achieved from the inside through the flow channel. This construction only allows for a flow distribution, but not for a delivery of respective nutrients within the aquarium.

One aspect of the present invention is to realize in a simple manner the improved delivery of fluids to aquaria, ponds or the like in which fluids nutrients for water inhabitants are dissolved, for example, oxygen.

### SUMMARY OF THE INVENTION

According to the invention, there is provided a tube section piece for providing and influencing a fluid for a container for water organisms, consisting of two tubular elements, which by means of a driving or actuating element are moveable with respect to each other, wherein the inflow of fluid occurs through the tubular elements. A further aspect of the invention is a device for flow distribution comprising such a tube section piece according to the invention.

The tube section piece according to the invention for providing a fluid for a container for water organisms, like living water animals, comprises a fixed tubular element and a moveably supported tubular element. These two tubular elements are rotatable with respect to one another via a drive element. In use, the fluid flows through the tube section piece, wherein the fluid successively flows through the two tubular elements. By means of a relative motion of the two tubular elements with respect to one another which is caused by the driving element, a flow direction of the fluid is influenced.

By means of the self-driven tube section piece effecting a swivelling or rotating movement, the container is supplied with fluid. Thus, within the container, i.e. an aquarium, basin, pond or the like, a non-uniform inflow is created, and within the container a changing flow distribution is achieved.

If the fluid consists of water in which nutrients or microorganisms for the water animals are contained, the invention operates reliably as well. According to the invention, such biological fluids may flow into the container, while creating turbulences, and may thereby improve the existence of an ecosystem contained therein, including water animals like fish, crabs, mussels, snails, water insects, water plants, amphibians and so on.

It is envisaged that the fixed and/or the moveably supported tubular element is/are provided with connection possibilities (connection devices) for tubular pieces, so that a tubular piece, such as a tube or a hose, may be provided in a watertight manner on at least one of the two tubular members. Therefore, the tube section piece may be modularly provided as an intermediate piece or as an end-piece in already existing pipings, such as tubes or hoses, in order to supply aquaria or ponds. The tube section piece is hollow inside, so that an uninhibited flow of fluid through the tube section piece is ensured. Further, the two tubular elements of the tube section piece according to the invention are disposed coaxially to each other. Further, the connection possibilities comprise fits, which are dimensioned according to need and/or are standardized.

According to a preferred embodiment, the moveably supported tubular element of the tube section piece comprises a tubular bend. The biological fluid, especially enriched by nutrients flowing into this fixed element therefore flows into the container under a permanent change of direction.

By means of the present invention an advantageous fluid flush of biological fluids, such as pond water or aquarium water, is possible. By means of the driving element and the rotatably supported tube section piece, for example an intermediate piece of a tube or an end piece of a tube in connection with an arbitrary nozzle attachment, a pivoting or turning, and thereby irregular fluid inlet or flow inlet, respectively, as well as associated therewith, a changeable flow distribution within the respective container, such as a pond or a basin, for water organisms or water animals living therein, is obtained.

It is envisaged that the driving element is designed as a controllable electrical motor with a corresponding transmission ratio or velocity control. Therefore, by use of such a driving source, a fluid flow is adjustable in a desired manner.

In an advantageous embodiment of the invention, the driving element is mounted to the fixed element and comprises a cog wheel, which engages with a cograil of the moveable element. The cog wheel may be connected to the driving element by means of a force transmission shaft, whereby said force transmission shaft is guided by a feedthrough provided within the fixed element. By means of this measure, it is possible to rotate the rotatably supported element with respect to the fixed element.

As a further embodiment, the fixed tubular element comprises an inner tube end section and an outer tube end section, which are coaxially disposed to each other and between which a tube end section of the moveably supported tubular element is disposed or inserted.

Between the two tubular elements of the tube section piece, at least one seal may be provided for lossless transport of the fluid, which, for example, is delivered by an external pumping force. Thus, a separation of gas and fluid flowing through the tube section piece according to the invention is ensured with respect to the environment.

According to the invention the biological fluid provided by an external pumping force is individually and variably distributed within the container, which results in an effective rinsing within the container, and associated therewith results in an improved distribution of oxygen and nutrients therein.

Further, the tube section piece may comprise a lock for guiding and holding the two tubular elements. Thereby, a frictionless course of motion of the two tubular elements during operation of the tube section piece, as well as a stability of the tube section piece is ensured.

In a preferred embodiment of the tube section piece, at least one stop is provided at the fixed tubular element, and at least one hole for inserting at least one insertable element (plug) thereto is provided at the rotatably supported tubular element. By means of this measure, a rotational movement of the rotatably supported element having the bend tube piece with respect to the fixed element is restricted to a definable angular interval. One or two insertable elements may thereby be selectively inserted into one of the holes.

The device for flow distribution according to the invention comprises a tube section piece according to the invention. By means of this device, an optimal supply of containers containing living water animals and other organisms with biological fluids is ensured, by means of the self-driven rotatable tube section piece.

By means of this invention, a flushing with improved flow of fluids is achieved in the context of garden ponds or aquaria. The tube section piece is disposed at the corresponding water inlet, and is driven in a simple manner independently with respect to pumping force or water force. The tube section piece is easy to mount, and may be provided with a rotatable inlet device or inlet nozzle which, if desired, may be adjustable.

Advantages, which may be achieved by means of the invention comprise that the tube section piece, which is to be disposed at the water inlet, is self-driven, and effects a rotatioinal movement of a tubular bend mounted to the moveably supported element. The flow of water created by an external pumping force is distributed in the pond or in the aquarium without losses and is individually modifiable, whereby a more effective rinsing or flushing is achieved, and associated herewith, a better supply with oxygen and nutrients is achieved.

Further advantages and embodiments of the invention follow from the description and the accompanying drawings.

It is to be understood that the above discussed features, and the features to be explained in the following are applicable not only in the respectively given combination, but in other combinations or used separately as well, without departing from the scope of the present invention.

### SHORT DESCRIPTION OF THE DRAWINGS

The invention is schematically illustrated with reference to an embodiment as shown in the drawings, and will now be described in detail with reference to the drawings.

FIG. 1 is a schematical sectional view, which shows a preferred embodiment of the tube section piece according to the invention.

FIG. 2 is an alternative schematic view, which shows the tube section piece according to FIG. 1.

### DESCRIPTION OF THE INVENTION

The figures will be explained interrelatedly and comprehensively, whereby the same reference signs denote the same parts.

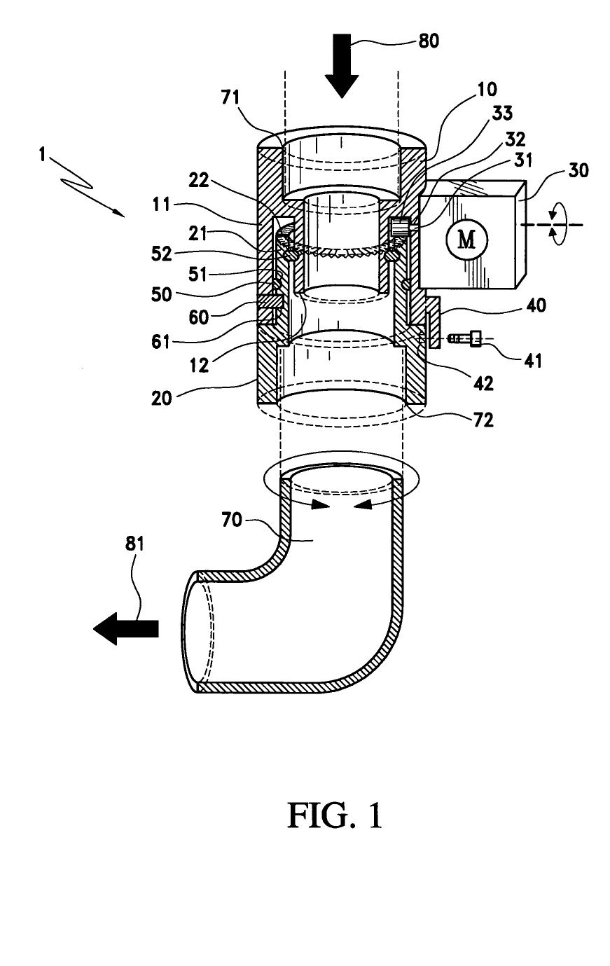

In the embodiment of the tube section piece 1 according to the invention for flow enhancing flushing of biological fluids, e.g. of water, containing nutrients and/or organisms, which is shown in FIG. 1 in sectional view, an upper, tubular, fixed element 10 with an outer tube end portion 11 and an inner tube end portion 12 coaxially disposed thereto substantially comprises a tubular element 20 moveably supported therein, comprising a tube end portion 21 of reduced diameter and a tubular bend 70 mounted to the moveably supported tubular element 10.

Herein, the tube end section 21 of the moveably supported element 20 is coaxially inserted or disposed between the outer and the inner tube end portions 11,12 of the fixed element 10.

The upper, fixed tubular element 10 comprising the tube end portions 11, 12 and the lower, moveably supported tubular element 20 comprising the tube end portion 21 are, by means of sealing rings 50, 52, inserted in grooves 51 and a lock 60 inserted in a groove 61, connected to one another in such a way that the tube end portion 21 of the lower rotatable element 20 may be moved within the tube end portions 11,12 of the upper fixed element 10.

By means of inserted standardized plug-in insertions or connection devices 71,72, hoses, tubes and bends 70 may be connected individually to the upper fixed tubular element 10, as well as to the lower, moveably supported tubular element 20.

The driving element 30 mounted to the upper, fixed tubular element 10 comprises a selectively appropriate transmission or velocity control, and is provided with a force transmission shaft 31, as well as with a cog wheel 33 mounted thereto. The force transmission shaft 31 is guided through a feedthrough 32 provided in the outer tube end portion 11 of the upper, fixed tubular element 10. The cog wheel 33 engages cograil 22 at the tube end portion 21 of the lower, tubular, moveably supported element 20 for transmitting force or motion.

Alternatively to the cog wheels 33 and cograils 22, a transmission of force or movement may take place by means of a belt drive, chain drive, pendular lift drive, friction drive, drive shafts or the like as well.

At least one stop 40 is provided at the lateral side of the tube end portion 11 of the upper, fixed element 10. At the lower element 20 at least one hole 42 is provided for inserting at least one plugging or insert element 41 therein, whereby the desired assembly of stop 40 and plugging element 41 serves to lock the upper, fixed element 10 to the lower, rotatably supported element 20. In addition, it is thus possible that especially by means of two insertable elements 41, which may selectively be chosen, an angular interval may be determined, within which the lower, rotatably supported element 20 rotatates back and forth with respect to the fixed element 10 in a desired manner, wherein the stop 40 at the upper element 10 serves to change a direction of rotational movement of the moveably supported element 20, as soon as one of the plugging elements 41 contacts the stop 40 in the course of its rotational or pivotal movement.

Water 80, which flows into the fixed element 10 in the direction given by the arrow, during the operation of the tube section piece 1 flows in the direction given by the arrow via the rotatably supported element 20 out of the bend 70, which rotates according to the double arrow, as re-directed water 81 flowing in various directions. A transport of the water 80, at first through the fixed element 10 and subsequently through the moveably supported element 20 occurs losslessly, due to the seals 50, 52 disposed therebetween.

Any motor or any motor-driven or magnet-driven pump, compressor, flow pump, water-jet pump, magnetic pulse pump, frequency pump, air pressure pump or the like may be applied as a direct or indirect driving source 30, wherein the transmission from an external driving source by means of threaded bolt, a bowden cable, a rope linkage, driving shaft or the like may be expedient.

The tube section piece 1 according to the invention may be designed to be made from a suitable material like metal, polymer, rubber or materials of other kinds, as well as combinations of the before mentioned materials, which show features that are appropriate to realize the invention.

Preferably, the invention is individually adjusted to a respective application and as far as its dimensioning and choice of materials is concerned, is preferably realized in such a way that it fulfills the respective requirements.

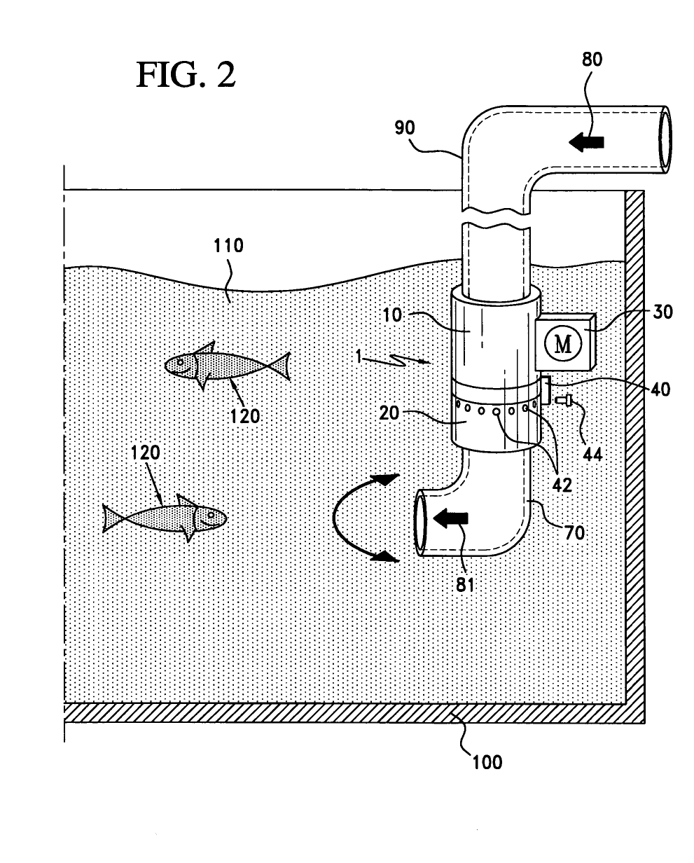

FIG. 2 shows the tube section piece 1 of FIG. 1 according to the invention, when applied in an aquarium 100 filled with water 110, in which aquarium there are fish 120. Here, the tube section piece 1 is, by means of the fixed element 10, mounted to a tube 90, by which water 80 containing oxygen and/or nutrients is delivered in the direction given by the arrow, and flows through the tube section end piece according to the invention.

By means of the driving element 30, the rotatably supported element 20, and thereby the tubular bend 70 mounted thereto, is brought into a back and forth directed pivotal movement defined by suitable disposition of plugging elements 41 in the openings 42 by contacting with the stop 40 (curved double arrow) while changing the direction, with respect to the fixed element 10 and thereby with respect to the tube 90. If one omits the positioning of the plugging elements 41, it is possible for the rotatably supported element 20, and thus the tubular bend 70, to perform an uninterupted rotation over 360°.

Water 81 exiting the tubular angled part 70 in the direction given by the arrow preferably flows continuously in varying directions into the aquarium 100, so that the water 110 contained therein is flushed or rinsed, the flow being improved and turbulences being created. Therefore, a water circulation and thereby a nutrient circulation and oxygen circulation is provided within the aquarium 100, which is beneficial for the fish 120 therein.

1. Tube section piece for providing a container for water organisms with fluid, wherein the tube section piece comprises a fixed, tubular element and a moveably supported tubular element, wherein the two tubular elements are rotatable with respect to one another by means of a driver element.

2. Tube section piece according to claim 1, wherein at least one of the two tubular elements is provided with a connection device for a tubular part.

3. Tube section piece according to claim 1, wherein the moveably supported tubular element comprises a tubular bend.

4. Tube section piece according to claim 1, wherein the driving element is designed as a controllable electric motor with internal transmission.

5. Tube section piece according to claim 1, wherein the two tubular elements are disposed coaxially to one another.

6. Tube section piece according to claim 1, wherein the driving element is mounted to the fixed element and comprises a cog wheel, which engages a cograil of the moveable element.

7. Tube section piece according to claim 1, wherein the fixed tubular element comprises an inner tube end section and an outer tube end section, which are coaxially disposed to one another and between which a tube end section of the moveably supported tubular element is disposed.

8. Tube section piece according to claim 1, wherein at least one seal is provided between the two tubular elements.

9. Tube section piece according to claim 1, comprising a lock for guiding and holding the two tubular elements.

10. Tube section piece according to claim 1, wherein at least one stop is provided at the fixed tubular element, and at least one hole for inserting at least one insertable element is provided at the rotatably supported element.

11. A Device for distributing flow, comprising a tube section piece according to any claim 1.
